(19) United States
(12) Patent Application Publication
(10) Pub. No.: US 2008/0280671 A1
(43) Pub. Date: Nov. 13, 2008

(54) Wagering Game System with Vacuum Fluorescent Display

(76) Inventors: James M. Rasmussen, Chicago, IL (US); Alfred Thomas, Las Vegas, NV (US)

Correspondence Address: SCHWEGMAN, LUNDBERG & WOESSNER/WMS GAMING, P.O. BOX 2938, MINNEAPOLIS, MN, 55402, US

(21) Appl. No.: 11/997,586

(22) PCT Filed: Aug. 24, 2006
(86) PCT No.: PCT/US06/33143

§ 371 Date: Feb. 1, 2008

Related U.S. Application Data
(60) Provisional application No. 60/710,836, filed on Aug. 24, 2005.

(51) Int. Cl. A63F 13/00

(52) U.S. Cl. 463/20

(57) ABSTRACT

A computerized wagering game system includes a gaming module comprising gaming code which is operable when executed on to conduct a wagering game on which monetary value can be wagered, and a vacuum fluorescent display assembly comprising at least one vacuum fluorescent display element.

### RELATED APPLICATIONS

This application claims the priority benefit of U.S. Provisional Application Ser. No. 60/710,836, filed Aug. 24, 2005, the contents of which are incorporated herein by reference.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### FIELD OF THE INVENTION

The invention relates generally to computerized wagering game machines, and more specifically to vacuum fluorescent displays in a computerized wagering game machine.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. It is not uncommon for audio voices to provide instruction and help, and to provide commentary on the wagering game being played. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

The displays were traditionally cathode ray tubes, or CRTs much like those used in standard televisions. But recently, CRT displays have given way to liquid crystal displays as the most common type of display used in new wagering game machines. While CRTs provided very good brightness and color fidelity, they were relatively large, heavy, fragile, and consumed a relatively large amount of power. LCD displays have limited brightness and contrast capabilities, and backlighting a large LCD display evenly and achieving accurate color fidelity are difficult. Other options include plasma displays, which have the color fidelity of CRTs and a small size similar to LCDs, but the contrast ratio, power consumed, and production cost are all inferior to other display technologies. These traditional display technologies are also not easily integrated with mechanical elements such as reels on a mechanical reel slot machine, limiting practical application to traditional rectangular opaque displays.

It is therefore desired to incorporate display technology into a wagering game system addressing the shortcomings of existing displays.

### SUMMARY

One example embodiment of the invention comprises a computerized wagering game system including a gaming module comprising gaming code which is operable when executed on to conduct a wagering game on which monetary value can be wagered, and a vacuum fluorescent display assembly comprising at least one vacuum fluorescent display element. The vacuum fluorescent display in some embodiments comprises a transparent vacuum fluorescent display element, transparent electrical conductors, or is an optically transparent display assembly. In some further embodiments, the vacuum fluorescent display elements are used to indicate paylines on a mechanical slot reel machine.

### BRIEF DESCRIPTION OF THE FIGURES

FIG. 1 shows a computerized wagering game machine, as may be used to practice some example embodiments of the invention.

FIG. 2 is a diagram of a wagering game system display panel incorporating vacuum fluorescent display elements, consistent with some example embodiments of the invention.

FIG. 3 is a cross-section view of a vacuum fluorescent display, consistent with some example embodiments of the invention.

FIG. 4 is a supply voltage diagram illustrating control signals supplied to operate the vacuum fluorescent display in some example embodiments of the invention.

FIG. 5 is a flowchart illustrating application of vacuum fluorescent display elements to payline indication in a mechanical reel slot machine, consistent with some example embodiments of the invention.

FIG. 6 shows an example payline configuration, as may be used to practice some example embodiments of the invention.

FIG. 7 shows a side view of a wagering game system employing mechanical reels and a vacuum fluorescent display element, consistent with some example embodiments of the invention.

FIG. 8 shows several example vacuum fluorescent display patterns having different vacuum fluorescent display element configurations, consistent with some example embodiments of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

The invention in one example embodiment comprises a computerized wagering game system including a gaming module comprising gaming code which is operable when executed on to conduct a wagering game on which monetary value can be wagered, and a vacuum fluorescent display assembly comprising at least one vacuum fluorescent display element. The vacuum fluorescent display in some embodiments comprises a transparent vacuum fluorescent display element, transparent electrical conductors, or is an optically transparent display assembly. In some further embodiments, the vacuum fluorescent display elements are used to indicate paylines on a mechanical slot reel machine, or to indicate other game elements such as bonus conditions or special status of a game element.

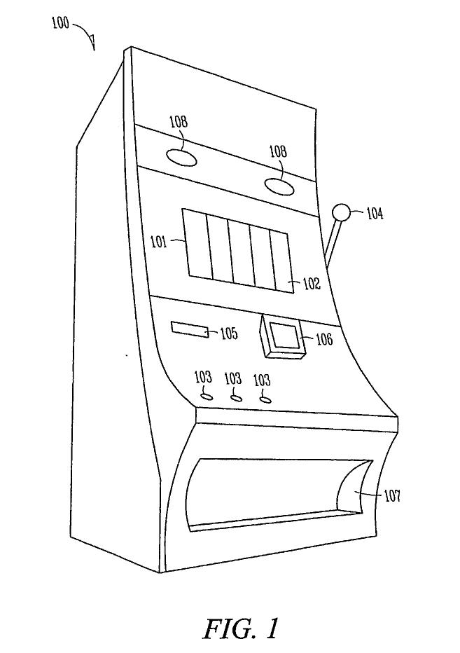

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. Alternate embodiments of the invention will have other game indicators, such as mechanical reels instead of the video graphics reels shown at 102 that comprise a part of a video slot machine wagering game. In one such embodiment, electromechanical reels bearing a number of reel symbols are rotated during game play, and are stopped at desired positions such that the desired reel symbols are physically positioned in a desired location with respect to various paylines used to indicate winnings. Although this illustration shows five reels, other reel configurations, such as three reels or addition of a bonus reel, are used in other embodiments. The reels are simulated in some embodiments by use of a display technology such as LCD, plasma, field emission, or CRT displays.

A wagering game is implemented using software within the wagering game, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The wagering implemented via the loaded software takes various forms in different wagering game machines, including such well-known wagering games as reel slots, video poker, blackjack, craps, roulette, or hold 'em games. The wagering game is played and controlled with inputs such as various buttons 103 or via a touchscreen overlay to video display 101. In some alternate examples, other devices such as pull arm 104 used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 105 or a secure user identification module interface 106, and winnings are returned via the returned value card or through the coin tray 107. Sound is also provided through speakers 108, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

In embodiments using mechanical reels 102, the wagering game designer's flexibility in altering, highlighting, or otherwise indicating specific reel symbols or positions is reduced relative to the flexibility of presenting the same information using a video display. But, some wagering game players strongly prefer to play slot machine wagering games that use mechanical reels, and so a variety of electromechanical reel slot machine products remain on the market, with ever increasing functionality and features. Increased numbers of paylines, multi-line wagering, and secondary display capabilities have resulted in mechanical reel slots with greater functionality than previous machines, but the mechanical reels have limited the ability to display special images or enhance the presentation of the reels or reel symbols themselves.

While the standard number of reels has increased progressively from three to five, and the maximum number of paylines has increased from a maximum of five to twenty, the ability of a wagering game machine using mechanical reels to clearly indicate a payline has diminished. Extending graphically drawn paylines over the reels obscures the reels and the reel symbols, so some manufacturers have taken to indicating a winning payline on a secondary display altogether. But, the game player's primary focus is on the mechanical reels, and so graphically indicating the payline on another region of the display or on another display is not an ideal solution.

Some embodiments of the invention therefore add such features as illumination or identification of specific reel symbols or paylines to mechanical reel slot machines. One embodiment of the invention achieves this by using selectively lightable vacuum fluorescent display elements to indicate reel positions or objects as well as paylines in mechanical reel slot machines. The vacuum fluorescent display is in some embodiments transparent, so that mechanical reel game symbols and other objects can be seen behind or near the display elements when not illuminated.

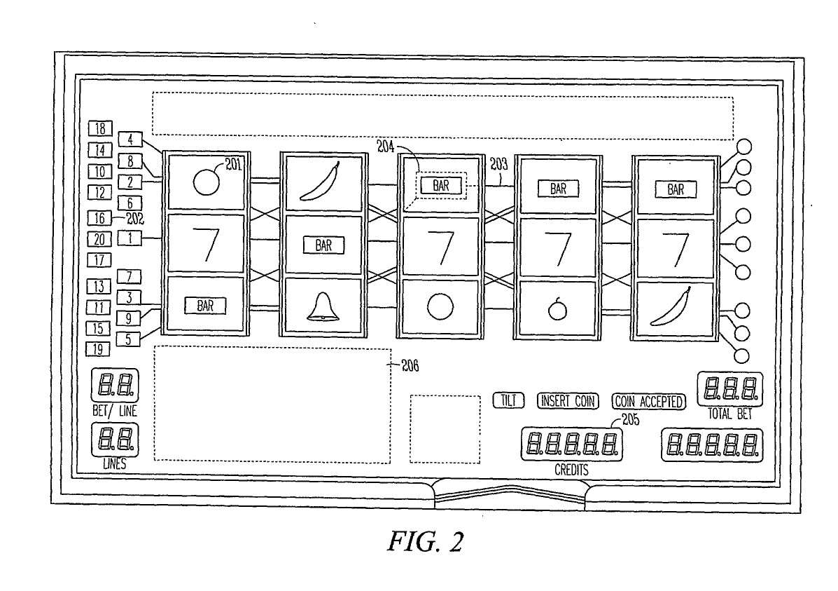

FIG. 2 illustrates an example embodiment of a reel slot machine, using vacuum fluorescent display elements as indicators in the wagering game. This illustration shows five mechanical reels 201 visible through cutouts or transparent portions of the front panel, and a variety of other indicators used to convey information regarding the wagering game. For example, payline indicators 202 are operable to indicate which numbered paylines are selected or on which credits are wagered, as well as to indicate a payline that has won after a round of reel slot machine play. The paylines are further indicated by lines such as 203 that link reel symbols to other reel symbols, making clear the path from reel to reel that a particular payline follows.

Some embodiments of the invention use vacuum fluorescent display elements to display select elements of the wagering game display shown in FIG. 2, such as the paylines 203. In one such embodiment, the segments 203 linking the reels to show a payline are formed using vacuum fluorescent display elements that are selectively lightable to show one or more particular paylines. In further embodiments, the vacuum fluorescent display elements include elements of different color, so that groups of paylines can be associated and so that different paylines can be distinguished form one another.

The paylines extend in a further embodiment through the mechanical reel windows 201, as is shown at 204. The vacuum fluorescent elements used to display the payline segment 204 are desirably transparent when not illuminated, so that the reel symbols on the mechanical reels can be clearly seen through the unlit payline. This is achieved in some embodiments by using transparent conductors such as indium tin oxide, and by using transparent phosphors such as are commercially available.

In some further embodiments, other elements of the reel slot display panel are illuminated using vacuum fluorescent display elements, including numeric or text character displays such as the credit counter 205, and graphic displays such as the graphic art section 206. The vacuum fluorescent display is particularly desirable for use in displaying symbols, graphics, or alphanumerics that are fixed in size or shape, as the vacuum fluorescent display elements can be formed in any shape and can therefore display many such images with greater detail or in higher effective resolution than a fixed pixel display. In other embodiments, vacuum fluorescent elements can be used to form a displayed image in a manner that is similar to a fixed pixel display, in which a number of vacuum fluorescent elements are illuminated to form a single image.

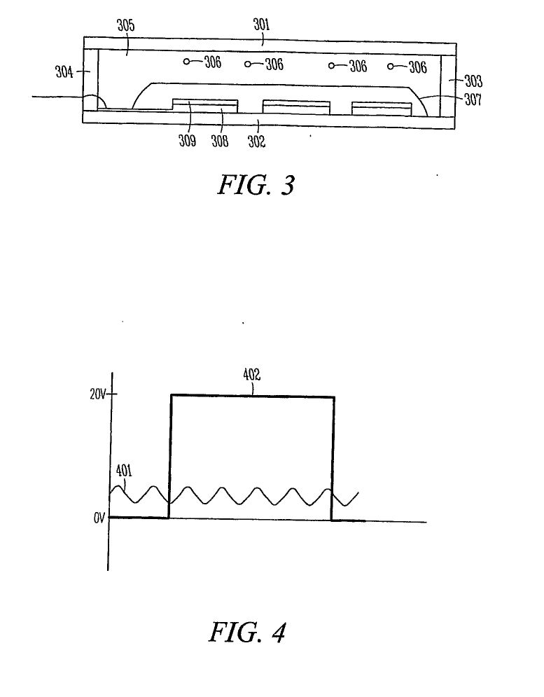

A more detailed cross-section of a vacuum fluorescent display device is shown in FIG. 3, as can be used on various embodiments of the invention. The assembly comprises a top or front glass panel 301, a back glass panel 302, and side glass panels 303 and 304. These glass panels form a sealed cavity 305, which has its air substantially evacuated such that it forms a vacuum. Several small, thin cathode filament wires 306 run across the display, shown here in an end view. A grid mesh 307 is similarly formed of a mesh of conductive filaments, and separates the cathode filaments 306 from the anodes 308. Each of the anodes 308 is coated with a phosphor layer 309, which emits light when struck with electrons.

The filament 306 typically comprises a thin tungsten wire coated with barium, strontium, and calcium oxides. The filament is suspended and under tension, so it remains stationary but suspended during operation. The grid 307 typically comprises a mesh of thin stainless steel wire, such as can be formed by photoetching. In many embodiments, different areas of the display will have separate grids, each of which can be separately powered as needed to enable or disable illumination of the phosphor-coated anode display elements underneath. The anode material 308 is a conductor such as graphite, which is coated with a phosphor such that the anode and phosphor form a shape or pattern that is part of the desired display image. In other embodiments, the conductor and phosphor are transparent, such that at least some light pasts through them. Examples of transparent anode or conductor materials include indium tin oxide, while transparent phosphors include zinc oxide and other such materials. Using different phosphors, or different additives to the selected phosphors, can result in different wavelengths of light emitted when excited by electrons, resulting in display segments of different color.

In operation, a filament voltage is applied to the filaments 306, such as an AC signal of a few volts in amplitude. The grid 307 is driven to a positive voltage, such as 15-20 volts, to accelerate electrons toward the anodes 308. The anodes 308 are themselves selectively driven to a positive voltage such as the same voltage as the grid or a more positive voltage, to attract the electrons and excite the phosphor coating 309. Those vacuum fluorescent display segments or elements that are to remain off or dark are not driven to a high voltage level, but remain at a low voltage level such as ground.

FIG. 4 shows an example of power and control signals used to operate a vacuum fluorescent display such as that of FIG. 3. A filament voltage 401 is applied to the filament, heating the filament to approximately 600 degrees Celsius. The filament voltage varies depending on the characteristics of the filament, but typical values include alternating current (AC) voltage signals of several volts, as shown in FIG. 4. The grid voltage is applied when at least one display segment under the grid is to be lit, and the anode forming the display element is similarly driven to an elevated voltage equal to or greater than the grid voltage as shown at 402.

When a particular grid associated with a vacuum fluorescent display element or region is inactive, it is driven in some embodiments with a voltage that is negative relative to the AC signal present on the filaments, ensuring that high energy thermal electrons emitted from the filaments 306 do not accelerate into the anode 308 and cause unwanted leakage luminance of the phosphors 309. This is shown in FIG. 4, by the AC filament voltage 401 being offset several volts positive from ground or zero volts, so that the filament voltage never drops below the “off” voltage supplied to inactive display segment anodes or grids for areas of the display that are turned off.

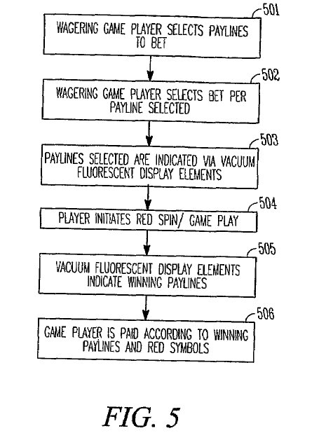

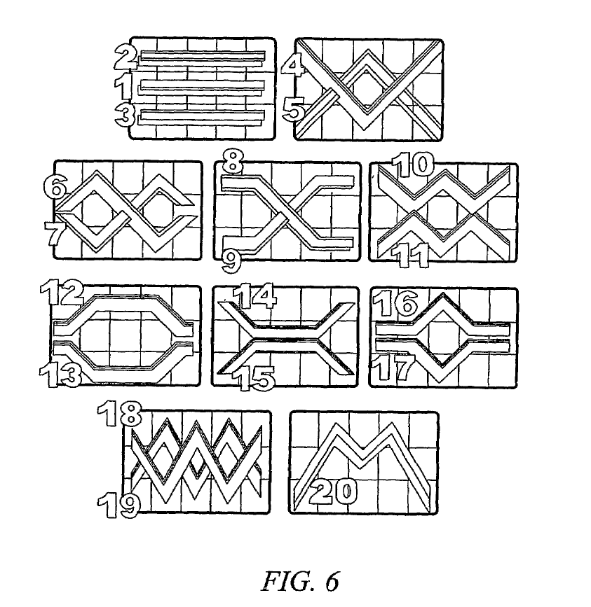

Application of a vacuum fluorescent display to a wagering game such as to the payline indicators 203 and 204 of FIG. 2 is explained in greater detail in the flowchart of FIG. 5. At 501, the wagering game player selects the number of paylines on which monetary value is to be wagered. A more detailed example of payline configurations is shown for reference in FIG. 6, which shows how up to 20 paylines can be played on a single reel spin. The player wagers a specified value on each of a selected number of paylines at 502 by specifying a monetary value amount per payline selected. In one example, the player is required to specify a single number of credits per payline such that the same value is bet on each payline played, and is required to simply select a number of paylines which are assigned for play in numeric order, such as paylines 1-3, 1-5, 1-9, etc. In other embodiments, the player can wager different amounts per line, and can select which individual paylines are to be bet. Selection of the paylines is illustrated in one example embodiment by illuminating the paylines with vacuum fluorescent display elements, such as 203 and 204 of FIG. 4, as is described at 503.

Once the paylines have been selected, and the bet per line has been selected, the slot reel wagering game player initiates a reel spin at 504. The positions of the various reel symbols relative to the paylines bet indicate whether and to what degree the player has won, and so are desirably displayed clearly and vividly to the wagering game player. In this example, the winning payline or paylines are therefore displayed using vacuum fluorescent display elements such as 203 and 204 of FIG. 2 at 505. The game player is then paid according to the winning paylines and reel symbols at 506.

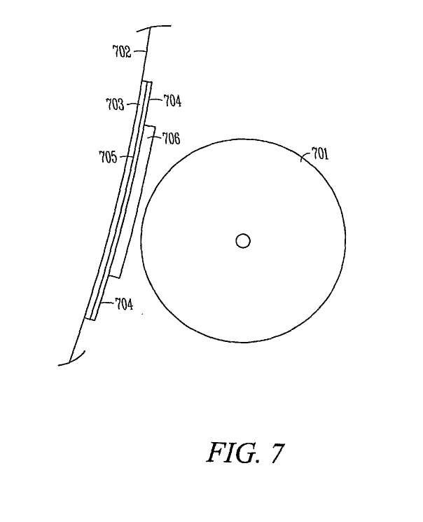

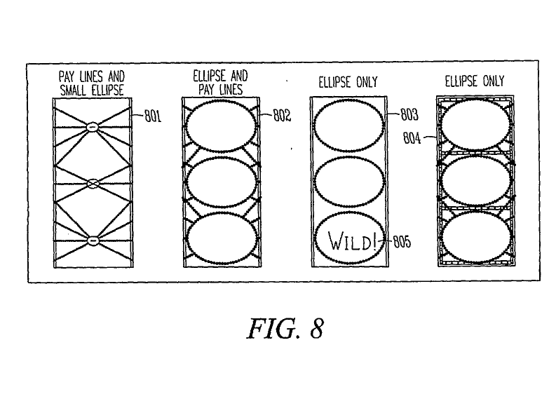

The vacuum fluorescent display is mounted to the wagering game system in some embodiments by mounting one or more displays between a front panel and mechanical slot reels, as is shown in FIG. 7. One or more reels 701 are located inside a wagering game cabinet 702, and behind a front protective panel 703. The panel is in some embodiments made of glass or another transparent material, and covers an art layer 704 such that the art layer is protected but can be seen through the glass. Further embodiments include a variety of other lights, display elements, and artwork incorporated into the front protective panel 703. The artwork layer 704 has an opening at 705, which allows a wagering game player outside the cabinet to see the mechanical reel 701 inside the wagering game cabinet 702. In this example, a vacuum fluorescent display 706, which in some embodiments closely resembles the vacuum fluorescent display panel shown in FIG. 3, is located behind the front protective panel.

In some embodiments, a single vacuum fluorescent display is used for each reel, while in other embodiments, smaller or larger displays are used to cover varying portions of the reel openings 705. The vacuum fluorescent display panels are attached to the front protective panel 703 in some embodiments using mechanical means, such as screws, clips, or other attachment mechanisms, and in other embodiments are attached using adhesive such as a double-sided adhesive tape.

Examples of individual vacuum fluorescent displays covering a single mechanical reel each are shown in example vacuum fluorescent displays 801-804 of FIG. 7, which illustrates both the size and shape of the vacuum fluorescent displays and various vacuum fluorescent display element patterns used to indicate paylines or reel symbols in various embodiments. The first example shown at 801 shows three small ovals, one over each reel symbol position, along with a variety of lines that can be selectively lit to indicate the portion of a payline extending through each vacuum fluorescent display panel's area. The second example uses larger ovals as shown at 802, so that the reel symbols can be more clearly seen through the oval when illuminated. The payline symbols extend to the edges of the larger oval, but do not extend inside the oval so that they do not obscure the reel symbols. The oval symbols alone are shown at 803, and may be used in some embodiments without further payline indicators to simply indicate specific reel symbols such as for showing which symbols are part of a winning payline or to indicate other status for specific reel symbols such as a wild or bonus condition. Still further embodiments use other vacuum fluorescent display segments and combinations of these segments to form shapes around one or more reel symbols, such as four-segment boxes configured around each reel symbol space where the segments can be selectively illuminated such that six segments can be used to form a single box around two adjacent reel symbols.

Wild or bonus symbols are also indicated in some embodiments by other indicators, such as a vacuum fluorescent display of an alternate color, or of a color that changes dynamically while displayed by altering the visible light given off by interleaved or closely spaced display elements of different colors. In other examples, further indicators are presented using vacuum fluorescent display technology, such as the word “WILD!”, as shown at 805. Other examples of indicating certain reel symbols include use of a vacuum fluorescent element shaped like a certain symbol, such as a number “7” that lights up, or that forms a halo or outline around a “7” reel symbol.

Certain reel symbols can be distinguished from other symbols by use of different symbol indicators such as by the combination of boxes and ovals shown in the vacuum fluorescent display example of 804. In one such example, the ovals and payline segments shown in 804 are used to indicate the winning reel symbols and the winning payline, while the boxes are used to indicate bonus symbols or scatter pay symbols. Scatter pay is an example of a winning symbol combination in which the winning symbols need not line up across a payline, but simply need be visible in one of the three reel symbol positions in one or more of the reels after game play. For example, a single number “7” visible on a reel may result in a modest winning of the bet amount, while four “7” symbols visible anywhere across all reels may result in substantial scatter pay winnings of hundreds or thousands of times the amount wagered.

The examples presented here illustrate how vacuum fluorescent display elements can be used in a wagering game display, including use of transparent vacuum fluorescent display elements having transparent conductors and transparent phosphors. Application to specific wagering games has also been shown as an example of how such vacuum fluorescent display technology can be used to selectively highlight or indicate game elements such as indicating paylines or winning reel symbols in a mechanical reel symbols in a traditional mechanical reel slot machine wagering game. The vacuum fluorescent display examples presented here are presented only as examples to aid in understanding application of the invention, and although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module comprising gaming code which is operable to present a wagering game on which monetary value can be wagered; and
a vacuum fluorescent display assembly, comprising at least one vacuum fluorescent display element.

2. The computerized wagering game system of claim 1, wherein the vacuum fluorescent display element is optically transparent.

3. The computerized wagering game system of claim 1, wherein the vacuum fluorescent display element is used to indicate a payline on a mechanical reel slot machine.

4. The computerized wagering game system of claim 1, wherein the vacuum fluorescent display comprises transparent electrical connections.

5. The computerized wagering game display of claim 1, wherein the at least one vacuum fluorescent display element comprises two or more elements of different color.

6. The computerized wagering game system of claim 1, wherein the vacuum fluorescent display assembly is transparent.

7. The computerized wagering game system of claim 1, wherein the at least one vacuum fluorescent display element is operable to emit light when a voltage is applied to an anode and a cathode of the vacuum fluorescent display, the applied voltage causing electrons to emit from the cathode and strike an anode coated in a phosphor which is operable when struck by electrons to emit light.

8. A method of operating a computerized wagering game system, comprising:
presenting a wagering game upon which monetary value can be wagered; and
producing light in a vacuum fluorescent display assembly by illuminating at least one vacuum fluorescent display element.

9. The method of operating a computerized wagering game system of claim 8, wherein the vacuum fluorescent display element is optically transparent.

10. The method of operating a computerized wagering game system of claim 8, wherein the vacuum fluorescent display element indicates a payline on a mechanical reel slot machine.

11. The method of operating a computerized wagering game system of claim 8, wherein the vacuum fluorescent display comprises transparent electrical connections.

12. The method of operating a computerized wagering game system of claim 8, wherein the at least one vacuum fluorescent display element comprises two or more elements operable to emit light of different colors.

13. The method of operating a computerized wagering game system of claim 8, wherein the vacuum fluorescent display assembly is transparent.

14. The method of operating a computerized wagering game system of claim 8, wherein illuminating at least one vacuum fluorescent display element comprises emitting light when a voltage is applied to an anode and a cathode of the vacuum fluorescent display, the applied voltage causing electrons to emit from the cathode and strike an anode coated in a phosphor which is operable when struck by electrons to emit light.

15. A computerized wagering game system display assembly, comprising:
at least one wagering game element operable to display the results of a wagering game upon which monetary value can be wagered; and
a vacuum fluorescent display assembly comprising at least one vacuum fluorescent display element that is operable to emit light.

16. The display assembly of claim 15, wherein the vacuum fluorescent display element is optically transparent.

17. The display assembly of claim 15, wherein the vacuum fluorescent display element indicates a payline on a mechanical reel slot machine.

18. The display assembly of claim 15, wherein the vacuum fluorescent display assembly comprises transparent electrical connections.

19. The display assembly of claim 15, wherein the at least one vacuum fluorescent display element comprises two or more elements operable to emit light of different colors.

20. The display assembly of claim 15, wherein illuminating at least one vacuum fluorescent display element comprises emitting light when a voltage is applied to an anode and a cathode of the vacuum fluorescent display, the applied voltage causing electrons to emit from the cathode and strike an anode coated in a phosphor which is operable when struck by electrons to emit light.
